(19) United States
(12) Patent Application Publication
(10) Pub. No.: US 2003/0163372 A1
(43) Pub. Date: Aug. 28, 2003

(54) Delivering content and advertisement

(76) Inventor: Mohammed H. Kolsy, Irvine, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/313,929

(22) Filed: Dec. 6, 2002

Related U.S. Application Data
(60) Provisional application No. 60/336,988, filed on Dec. 7, 2001.
(60) Provisional application No. 60/337,793, filed on Dec. 10, 2001.

(51) Int. Cl. G06F 17/60

(52) U.S. Cl. 705/14

(57) ABSTRACT

A method and apparatus for delivering content and advertisement is described. In one embodiment, the method includes: receiving a request for a target web page; sending, in response to the request for the target web page, a frames page including a plurality of frames and a frames page program module, where the plurality of frames comprises a content frame and an advertisement frame; receiving a request to load the content frame; sending content to load the content frame, where the content includes the target web page; receiving a request to load the advertisement frame; and sending an advertisement to load the advertisement frame. In another embodiment, the method includes: receiving a request for a target web page; sending, in response to the request for the target web page, a web page that causes, directly or indirectly, establishing a frames page including a plurality of frames and a frames page program module, where the plurality of frames includes a content frame and an advertisement frame; receiving a request to load the content frame, where the request to load the content frame is prompted by the frames page program module; sending content to load the content frame, where the content includes the target web page; receiving a request to load the advertisement frame, where the request to load the advertisement frame is prompted by the frames page program module; and sending an advertisement to load the advertisement frame.

### CROSS-REFERENCE TO RELATED APPLICATIONS

This application claims the benefits of U.S. Provisional Application Serial Nos. 60/336,988 and 60/337,793, filed Dec. 7, 2001, and Dec. 10, 2001, respectively, and entitled “Technology for Delivering Web Pages and Ad Messages in Split Screen Configuration Without Programming” and “Dual Frame Technology for Interstitial Advertising/Messaging on the Internet or Any Network Environment,” respectively, both of which are incorporated herein by reference.

### BACKGROUND OF THE INVENTION

1. Field of the Invention

This invention relates generally to delivery of information and, in particular, to delivery of primary content and advertisement.

2. Description of the Related Art

Many conventional methods of advertisement delivery over a network, such as the Internet, involve web pages which are coded to account for advertisements associated with the pages. In some methods, the advertisement is displayed as part of the web page. In such a case, the advertisement has a predetermined assignment of size and location in the displayed web page. This predetermined assignment is part of the coding for the web page. Modifying this predetermined assignment requires recoding of the web page.

In some methods, the advertisement is displayed during the interstitial time between display of web pages. In such methods, the web page includes tag lines that send requests for retrieving the associated advertisement from the proper server before displaying the subsequent web page. In such a method, when a user clicks on a hyperlink for next page the tagline for advertisement gets activated and is downloaded first by the client before the requested web page is retrieved. This creates a delay in receiving the advertisement at the client. Moreover, it does not provide for modifying the association, between the web page and the advertisement without recoding the web page as the association is part of the coding for the web page. In addition, these prior art methods are capable of delivering only one type of advertisement display system.

In all of the above methods, recoding or reprogramming of the web page is required to modify the predetermined relationships between the web page and the advertisement.

The present invention addresses this and other disadvantages of existing methods.

### BRIEF SUMMARY OF THE INVENTION

The present invention encompasses a method of delivering content and advertisement. In one embodiment, the method includes: receiving a request for a target web page; sending, in response to the request for the target web page, a frames page including a plurality of frames and a frames page program module, where the plurality of frames comprises a content frame and an advertisement frame; receiving a request to load the content frame; sending content to load the content frame, where the content includes the target web page; receiving a request to load the advertisement frame; and sending an advertisement to load the advertisement frame.

In another embodiment, the method includes: receiving a request for a target web page; sending, in response to the request for the target web page, a web page that causes, directly or indirectly, establishing a frames page including a plurality of frames and a frames page program module, where the plurality of frames includes a content frame and an advertisement frame; receiving a request to load the content frame, where the request to load the content frame is prompted by the frames page program module; sending content to load the content frame, where the content includes the target web page; receiving a request to load the advertisement frame, where the request to load the advertisement frame is prompted by the frames page program module; and sending an advertisement to load the advertisement frame.

The present invention is explained in more detail below with reference to the drawings.

### BRIEF DESCRIPTION OF THE DRAWINGS

FIG. 1 is a block diagram of a client and server and the general interaction therebetween according to one embodiment of the present invention.

FIG. 2 is a block diagram of major software components on the client side in one embodiment of the present invention.

FIG. 3 is a block diagram of major software components on the server side in one embodiment of the present invention.

FIG. 4 is an interaction diagram for browsing a web site in accordance with one embodiment of the method of the present invention.

FIG. 5 is an interaction diagram for navigating a web site in accordance with one embodiment of the method of the present invention.

FIG. 6 is an interaction diagram for clicking on an advertisement in accordance with one embodiment of the method of the present invention.

FIG. 7 is an interaction diagram for exiting a web site in accordance with one embodiment of the method of the present invention.

FIG. 8 shows a flowchart of major functions of the frames page builder script (index.php) in one embodiment of the present invention.

FIG. 9 shows a flowchart of major functions of the content caching script (adload.php) in one embodiment of the present invention.

FIG. 10 shows a flowchart of major functions of the advertisement display script flow chart (adview.php) in one embodiment of the present invention.

### DETAILED DESCRIPTION OF THE INVENTION

The present invention comprises a method of delivering content and advertisement. The following description is presented to enable any person skilled in the art to make and use the invention, and is provided in the context of a particular application and its requirements. Various modifications to the embodiments shown will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The present invention is described in relation to the delivery of content and advertisement. However, it is to be noted that the present invention is not limited to the delivery of content and advertisement. Instead, it is broadly applicable to the delivery of first and second types of information. For example, it is applicable to the delivery of a first primary content and a second primary content.

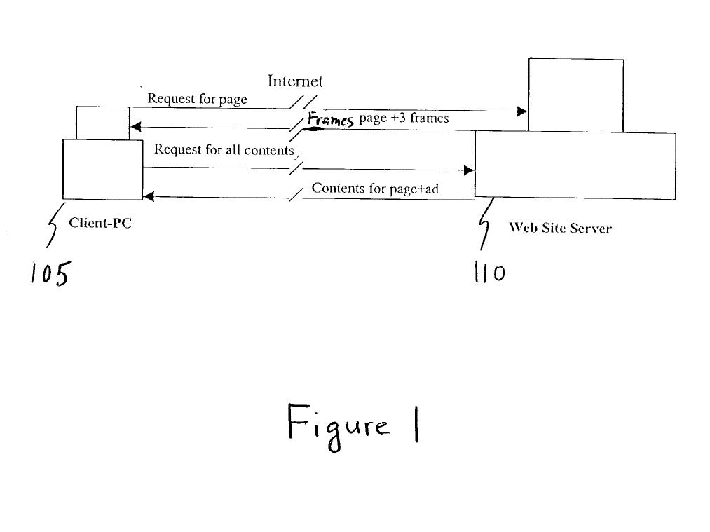

FIG. 1 is a block diagram of a client and server and the general interaction therebetween according to one embodiment of the present invention. In FIG. 1, client 105 is coupled to server 110. In one embodiment, client 105 is a computer, while server 110 is a web server, and client 105 is coupled to server 110 via the Internet. The server 110 includes the server-side software of the present invention. In another embodiment, client 105 may be coupled to server 110 via an intranet or some other type of network.

FIG. 1 also shows, at a general level, the interaction between the client 105 and the server 110 in one embodiment of the present invention. The client 105 sends a request for a web page or web site to the server 110. The server 110 receives the request. If during the current session between the client 105 and server 110, the request is a first request from client 105 for the web page or web site, then the server 110 sends a frames page (also herein referred to as an index page or holder page) and a plurality of empty frames to the client 105. More specifically, a frames page, among other things, defining a plurality of empty frames is sent to the client 105. In one embodiment, the page sent by the server 110 in response to the first user request can be a JavaScript script or a reference to a program that when executed by the browser effectuates the same result, i.e., establishing in the client browser a frames page and the plurality of empty frames.

In one embodiment, if the request has no frames page identification and is a content request, then it is determined to be a first request. In other words, if the request Universal Resource Locator (URL) refers directly to a content web page rather than an ad server component, then it is a first request. The client 105 stores the frames page and plurality of empty frames in the browser cache. Once the frames page is received at the client 105, it supersedes some of the browser functionality, particularly those relating to the user interface, at the client 105.

In one embodiment, two empty frames are sent from the server 110 to the client 105. One empty frame is a content frame for loading the requested web page. Another empty frame is an advertisement frame for loading an advertisement. In another embodiment, three empty frames are sent from the server 110 to the client 105. The three empty frames include a content frame, an advertisement frame, and a daemon frame. The daemon frame is for storing a record of the browsing activity during the session.

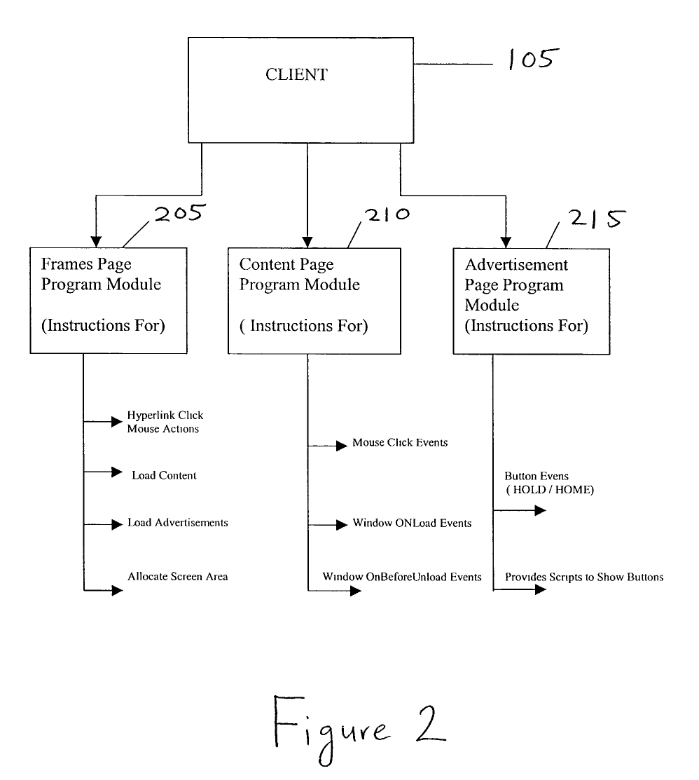

The frames page includes part of the client side software used in performing the method of the present invention. FIG. 2 is a block diagram of major software components on the client side in one embodiment of the present invention. As shown in FIG. 2, major software components on the client side include a frames page program module 205, a content page program module 210, and an advertisement page program module 215.

As shown in FIG. 2, the frames page program module 205 includes software for performing the following functions: (1) handling hyperlink mouse click actions; (2) loading content; (3) loading advertisements; and (4) allocating screen area. In one embodiment, the frames page program module 205 includes programming code, such as JavaScript scripts, for performing these functions. In one embodiment, the JavaScript scripts are used with Hypertext Markup Language (HTML) codes. Appendix 1 shows an example of the JavaScript scripts included in the frames page program module 205. It is to be noted that the frames page program module 205 can be written in other languages besides JavaScript (e.g., JScript or other non-Java based languages).

Handling the hyperlink mouse click actions involves monitoring for and responding to hyperlink mouse click actions. Loading content involves sending or prompting the sending of a request for the content of a web page, such as the web page previously requested by the client 105. Similarly, loading the advertisement message involves sending or prompting the sending of a request for the advertisement message and loading the advertisement message into the advertisement frame. Finally, allocating screen area involves splitting the screen area allocated to the browser between the content frame and the advertisement frame. It also involves adjusting or reallocating the distribution of the screen area between the content and advertisement frames. As used herein splitting includes allocating screen area such that one of the frames has only a 0% of the screen area. For example, it includes making a 0% and 100% allocation of the screen area between the content frame and the advertisement frame.

As noted above, once the frames page is received at the client 105, it supersedes some of the browser functionality at the client 105. Under control of the frames page, more specifically the script in the frames page program module 205 related to the function of loading content, the client 105 sends a request for the content of the web page previously requested by the client 105. In response, the server 110 retrieves the requested content and adds to the content page scripts for performing the following functions: (1) handling mouse click events; (2) handling window OnLoad events; and (3) handling window OnBeforeUnload events. These scripts may herein be referred to as scripts in the content page program module 210. In one embodiment, the server 110 modifies the content page by rewriting URLs in the content page such that they include a reference to the server 110, more specifically the adext.dll module of the server 110. Each rewritten URL references a web page via the server 110, more specifically the adext.dll module of the server 110, rather than referencing the web page directly. In another embodiment, rather than modifying the content page by rewriting the URLs therein, the server 110 adds a one line JavaScript script to the content page. This one line JavaScript script intercepts hyperlink clicks on the content web page by the user. It also dynamically rewrites the URL corresponding to the hyperlink such that the user click is redirected to the server 110. Accordingly, the requests represented by these hyperlink clicks are then forwarded to the server 110. In one embodiment, an advertisement identification (ID) is added to the content page. The advertisement ID identifies an advertisement associated with the content page. Thereafter, the server 110 sends the content page with the scripts of the content page program module 210 to the client 105.

As shown in FIG. 2, the content page program module 210 includes instructions for performing the functions of: (1) handling mouse click events; (2) handling window OnLoad events; and (3) handling window OnBeforeUnload events. Appendix 2 shows an example of the JavaScript scripts included in the content page program module 210. It is to be noted that the code in the content page program module 210 can be written in other languages besides JavaScript (e.g., JScript or other non-Java based languages).

Handling mouse click events involves monitoring for and responding to mouse click events. If the mouse click event involves a hyperlink click event, then the content page program module 210 notifies the frames page program module 205 of the event. Handling window OnLoad events involves three important functions: initiating the retrieval of subsequent content (using Ad ID, ad page is retrieved in this case), “content loaded” flag is set, and certain conditions are checked with configurations in the frames page to determine whether to load the next advertisement. In one embodiment, the performance of these functions involves notifying the appropriate scripts in the frames pages program module 205. Similarly, handling window OnBeforeUnload events involves handling events prior to the unloading of windows. An example of such an event includes setting up a number of global variables and LoadAd function is called in the holder scripts. When content is unloaded from a content frame in the window, the content page program module notifies the frames page program module of the unloading. Thereafter, the frames page program module displays an advertisement in the advertisement frame on the window by resizing the content frame to 0% of the screen area and the advertisement frame to 100% of the screen area for interstitial display.

The client 105 receives the content page, which includes the content page program module 210. Under the direction of the scripts for loading content, the empty content frame is filled with the content page. Thereafter, the content page is displayed on the screen at the client 105.

In one embodiment, upon receiving the content page, per the instructions in the frames page, more specifically, the scripts for loading the advertisement message, the client 105 sends a request to the server 110 for the advertisement. The server 110 retrieves the advertisement page and adds to the advertisement page scripts for performing the following functions: (1) displaying buttons, such as “HOLD” and “HOME,” and (2) handling button click events for the “HOLD” and “HOME” buttons. The “HOME” button may also herein be referred to as a “LEARN MORE” button. Thereafter, the advertisement page with the above mentioned scripts is sent to the client 105.

As shown in FIG. 2, the advertisement page program module 215 includes instructions for performing the functions of: (1) displaying buttons, such as “HOLD” and “HOME” buttons, and (2) handling button click events for the “HOLD” and “HOME” buttons. Appendix 3 shows an example of the JavaScript scripts included in the advertisement page program module 215. It is to be noted that the code in the content page program module 210 can be written in other languages besides JavaScript (e.g., JScript or other non-Java based languages).

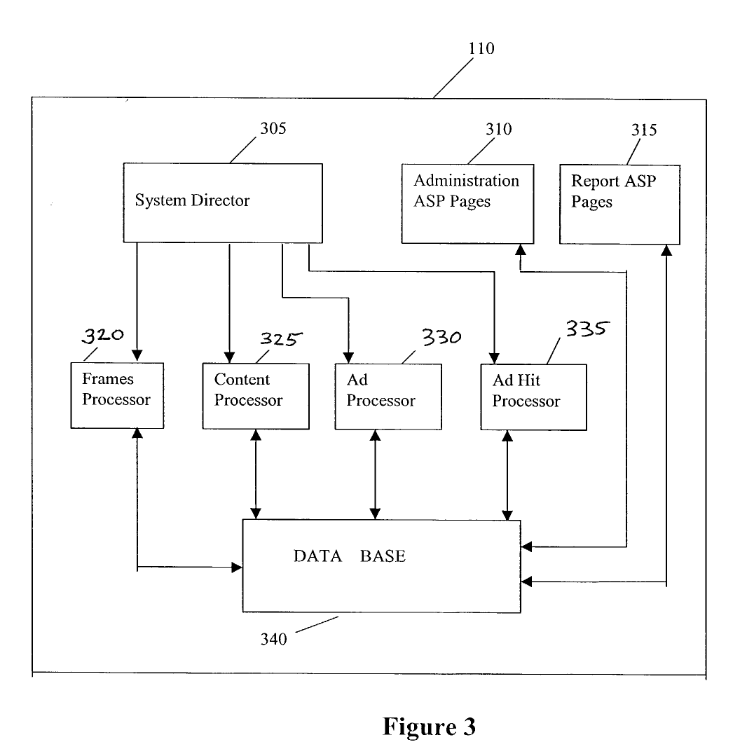

When a user clicks on a “HOLD” button associated with an advertisement, the advertisement page program module 215 captures the “HOLD” button click event. Thereafter, the advertisement page program module 215 notifies the frames page program module 205 of the “HOLD” button click event. The frames page program module 205 continues to display the advertisement even if the content page with which the advertisement is associated is no longer displayed on the window. In one embodiment, a user is able to surf through the web site while a video clip advertisement continues to play on the screen in split screen mode (which is described in greater detail below). When a user clicks on a “HOME” button associated with an advertisement, the advertisement page program module 215 captures the “HOME” button click event. Thereafter, the advertisement page program module 215 notifies the frames page program module 205 of the “HOME” button click event. The frames page program module 205 opens a new browser window in which the home page of the advertiser is displayed. In one embodiment, the URL of the advertiser's home page is stored in the database 340 (shown in FIG. 3) and maintained using the administrative ASP pages 310 (also shown in FIG. 3). The frames page program module 205 retrieves this URL from the database 340.

In one embodiment, an advertisement that is associated with the content page is retrieved and sent to the client 105. In one embodiment, the advertisement is selected based on the advertisement ID mentioned above. In one embodiment, the advertisement is randomly selected from a list of advertisements that are associated with the content page.

In one embodiment, the advertisements are stored as HTML files on an advertisement server which may be server 110 or some other server. The HTML files may be rewritten by the Display Script to insure that HTML tags and attributes for image, flash, video, or other content refer to the correct URL within the web site.

The client receives the advertisement page with the above mentioned scripts. Under the direction of scripts in the frames page for loading the advertisement message, the advertisement frame is filled with the advertisement page.

There are two general embodiments for displaying of the advertisement page in the present invention. In one embodiment, the advertisement page is displayed on the screen concurrently with the content page in multiple frames. Such an embodiment is herein referred to as a split screen mode of the present invention. In another embodiment, the advertisement page is displayed only between, in terms of time, the display of successive content pages. In other words, it is displayed during the interstitial time period between displaying content pages. Such an embodiment may herein be referred to as an interstitial mode embodiment of the present invention. In the interstitial mode embodiment, the loaded advertisement page is stored in the browser cache while the web page content is displayed.

In one embodiment, the content frame and the advertisement frame are allocated 100% and 0% of the screen area (more specifically, the area allocated to the browser window), respectively. This allocation is maintained while the content page is active. Once the user initiates a request to retrieve another web page, either within or outside the web site to which the current web page belongs, the scripts for allocating screen area adjust the allocation of display space to the content and advertisement frames. With this adjustment, the content frame and advertisement frame are allocated 0% and 100% of the screen, respectively. Consequently, the advertisement frame with the advertisement page therein is displayed on the screen at client 105. The advertisement page is displayed relatively quickly because, as noted above, prior to the adjustment in allocation it was already preloaded in the background in browser cache.

In one embodiment, the advertisement page is displayed until the next requested page is received by the client 105. The next requested page replaces the content page. Thereafter, the allocation to the content frame and advertisement frame is readjusted to 100% and 0%, respectively. In another embodiment, the advertisement frame with the advertisement page therein is displayed until an advertisement duration timer runs out.

The above-described embodiments implement a time-division multiplexing aspect of the present invention wherein the available screen space is entirely devoted at any one time to the display of either the content page or the advertisement page.

In another embodiment, the content frame and the advertisement frame are both allocated a non-zero percentage of the screen area. In one embodiment, the content frame and the advertisement frame are allocated 80% and 20% of the screen, respectively. In another embodiment, other non-zero percentages may be allocated to the content frame and the advertisement frame. In one embodiment, the screen is divided vertically between the content and advertisement frames. In another embodiment, the screen is divided horizontally between the content and advertisement frames. In yet another embodiment, there may be a combination of horizontal and vertical division or some other type of division between the content and advertisement frames displayed on the screen.

The embodiments described in the preceding paragraph implement a bandwidth division multiplexing aspect of the present invention wherein the available screen space is devoted at any one time to the display of both the content page and the advertisement page.

In the embodiment where both the content frame and advertisement frame are allocated a non-zero percentage of the screen, the content and advertisement frames (with the content and advertisement pages therein, respectively) are displayed together. If the content of the web page does not fit within the allocated space, e.g., 80% of the screen space, then the client would automatically add a horizontal scroll bar which a user may scroll to view the full page.

In one embodiment, as the content page is filled before the advertisement page is received at the client 105, the content page is displayed in the area allocated to the content frame, while the empty advertisement frame is displayed in the area allocated to it. Once the advertisement is received at the client 105, it is displayed in the area allocated to the advertisement frame.

In one embodiment, the daemon frame is initially loaded with a blank page. It is thereafter loaded with server-side scripted content as needed. This causes the Advertisement Server to log advertising events, such as, advertisement views, clicks, and holds. When a user clicks the Hold Advertisement button on an advertisement, or clicks an advertisement to view the advertiser's web site, the JavaScript scripts in the advertisement page causes the daemon frame to load the Logger Script (logger.php) from the web site with query parameters containing the advertisement ID, user action taken, and content page being displayed. Appendix 4 shows an example of the JavaScript scripts included in the Logger Script (logger.php). The Logger Script makes a request to a server to insert the advertising event information into the tracking database for later use in generating invoices.

FIG. 3 is a block diagram of major software components on the server side in one embodiment of the present invention. As shown in FIG. 3, server 110 includes the following software components: system director 305, administration Application Service Provider (“ASP”) pages 310, report ASP pages 315, frames processor 320, content processor 325, advertisement processor 330, advertisement hit processor 335, and database 340. Each of frames processor 320, content processor 325, advertisement processor 330, and advertisement hit processor 335 comprises software code. The software codes of these different processors may be executed on the same or different computer hardware devices.

Server 110 forwards to system director 305 incoming requests for web pages. The system director 305 qualifies the request. Appendix 9 shows codes developed (adfilter.dll) for the System director. As part of the qualification, the system director 305 determines whether a request for a web page is the first request during the current session between the client 105 and server 110. After qualifying the request, the system director 305 forwards the request to the appropriate one of frames processor 320, content processor 325, advertisement processor 330, and advertisement hit processor 335 based on the nature of the request.

If the request is a first request, then system director 305 forwards it to frames processor 320. Frames processor 320 builds a frames page and empty frames which are sent to the client 105. The frames page and empty frames are described in greater detail above.

If, on the other hand, the request is a second or subsequent request in the current session between the client 105 and server 110, then the request is forwarded to the appropriate one of content processor 325, advertisement processor 330, and advertisement hit processor 335 based on the nature of the request. Content processor 325 handles requests for content. Content processor 325 pulls the requested content page from database 340 and adds the content page program module 210 (shown in FIG. 2) thereto. It thereafter forwards the content page with the content page program module 210 to the client 105 so that it would be filled into the content frame at the client 105. In one embodiment, every time a new content page is requested by the client 105, a content page program module 210 is appended to the requested content page, and the requested content page with the content page program module is sent to the client 105.

As noted above, in one embodiment, the URLs in a content page are rewritten such that they include a reference to the server 110, more specifically the adext.dll module of the server 110. As also noted above, in another embodiment, rather than modifying the content page by rewriting the URLs therein, a one line JavaScript script is added to the content page. As further noted above, in one embodiment, an advertisement ID is added to the content page. In one embodiment, the content processor 325 performs the above modifications/additions to the content page.

Similarly, advertisement processor 330 handles requests for advertisements. Advertisement processor 330 retrieves an advertisement from the database 340 and adds the advertisement page program module 215 (shown in FIG. 2) thereto. It thereafter forwards the advertisement page with the advertisement page program module 215 to the client so that it would be filled into the advertisement frame at the client 105. In one embodiment, every time an advertisement page is sent to the client, an advertisement page program module 215 is appended to the advertisement page before it is sent to the client 105.

Appendix 5 shows an example of the JavaScript scripts included in the advertisement processor (AdExt.dll). The scripts in Appendix 5 include scripts for performing the functions of the following components in FIG. 3: the system director 305, the frames processor 320, the content processor 325, the advertisement processor 330, and the advertisement hit processor 335.

The advertisement hit processor 335 tracks the behavior of the user in relation to the displayed advertisements. The advertisement hit processor 335 forwards the tracked information regarding the user's behavior to database 340.

Database 340 may include the following tables: an advertisement table, a web sites table, a web sites advertisement links table, a clients table, a license table, a configuration table, and a hits (or tracking) table. The web sites advertisement links table links content pages with advertisements. In one embodiment, a content page may have multiple associated advertisements. In one embodiment, the multiple associated advertisements are displayed sequentially while displaying the content page with which they are associated. In one embodiment, these advertisements are all shown for the same length of time. In another embodiment, some of these advertisements are shown for a longer period of time than others. The length of time for which an advertisement is shown depends on its display weighing factor. The configuration table configures the software at the server side.

The configuration table contains global options that control the overall operation of the advertising system. The keys and values stored in this table are loaded by and used by server-side scripts. In most cases, the key name for a specific configuration item is used as the variable name by which server-side scripts can access the configuration data. In one embodiment, the present invention defines the following configuration options:

| | |
|---|---|
| Split Screen | Percentage of window width allocated to Split Screen |
| Size | advertising. |
| Split Screen | Set to “Y” or “Yes” to display advertising in |
| Mode | Split Screen mode. Any other value enables intersti- |
| | tial mode. |
| ExternalAds | Set to “Y” or “Yes” to display advertising |
| | when linking to content on other web sites. Any other |
| | value causes hyperlinks to other sites to display with- |
| | out advertising. |
| EnableNetscape | Set to “Y” or “Yes” to enable advertising display on |
| | Netscape and Mozilla web browsers with version |
| | numbers 6 or higher. Any other value causes the |
| | advertising system to be disabled for all Netscape and |
| | Mozilla browsers. |
| EnableHold | Set to “Y” or “Yes” to enable the Hold Page button |
| | in the Advertisement Frame. When enabled and the |
| | HOLD button has been pressed, clicking hyperlinks |
| | in the Content Frame will not cause the content of the |
| | Advertisement Frame to change. |

The license table contains license keys issued to customers who have purchased or are licensed to use the software of the present invention. The license data includes license type codes, licensed product codes, and the Fully Qualified Domain Name (FQDN) of the web site to which a license has been granted, or the IP address if the web site does not have a FQDN. In one embodiment, the license data is encrypted using the industry standard MD5 Hash algorithm producing a license key which the customer can install to activate the software of the present invention on their licensed web site.

The client table lists clients and their associated web sites for the purpose of generating invoices for all advertising generated by that web site.

The web site table lists the complete URL for each page that will display advertising and assigns a page ID to each page.

The advertisement table lists all potential advertisements, including the client of the advertisement, the prices for impression, hold, and click-through events, the location of the advertisement HTML, the destination URL, and the duration that the advertisement should be displayed. The advertisement table is associated with the client table by client name, and with the web site table by page URL.

The tracking table contains information about advertising events, including advertisement impressions, advertisement holds, and advertisement clicks. The table stores the advertisement ID, the content page URL, the date and time of the event, and the user action.

The administration ASP pages 310 enable administration of the site. For example, the administration ASP pages allow for changing the configuration options stored in the database 340. The report ASP pages 315 allow for generating reports and delivering them over a network, e.g., the Internet. A report regarding the number of impressions per advertisement would be an example of such reports. In one embodiment, access to the administration ASP pages 310 and report ASP pages 315 is limited to responsible personnel using security methods well known in the art.

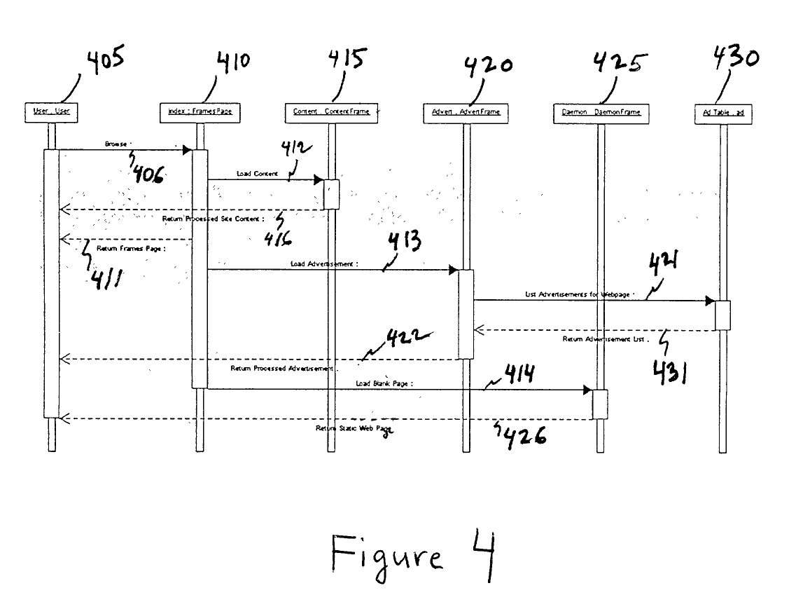

FIG. 4 is an interaction diagram for browsing a web site in conjunction with one embodiment of the method of the present invention. In response to a user 405 browsing 406 of a web site enabled with the software of the present invention, an index program module 410 returns 411 a frames page to the client. Loading of the frames page at the client triggers the loading of the content, advertisement, and daemon frames. More specifically, loading of the frames page triggers load requests for the content, advertisement, and daemon frames. It also triggers a request 412 to the content program module 415 to load the content frame with the contents of the web page that the user originally requested. In response to this request, the requested content is returned 416 to the user in the filled content frame. Before returning the content page to the user, the content page program module 210 (shown in FIG. 2) is appended to the content page. In one embodiment, in addition to the content page program module, a one line JavaScript script, pointing to Adsys.php module in the server 110, is added to the content page. The Adsys.php based configuration performs much the same functions as the frame page or Index.php method (in which, as described above, the initial page sent from the server 110 includes the frameset definition code), but uses a different method to install the frameset operating environment needed by the software. Appendix 10 shows the code in the Adsys.php module. In this embodiment, each web page in the site must be modified with the addition of a single line of JavaScript code at the top of the page text. The Adsys JavaScript line is added by the software through the administration screens. This single line accesses the Ad Server 110 to retrieve dynamically generated JavaScript code, which when executed at the browser, establishes the frameset, and loads the appropriate content into each frame just as the Index.php method does. The primary differences as compared to the Index.php method include (1) transparently installing the frameset environment such that the user cannot tell that the advertisement system is not in fact part of the original site content, (2) content caching is preferably not performed on the website content, and (3) click handling within the content frame is handled by JavaScript code that supersedes the normal browser and redirects clicks to the Advertisement Frame for handling.

In another embodiment, instead of adding this one line JavaScript script, each of the requested content pages are processed by the server 110 (in one embodiment, the content processor 325 on the server 110) so that each URL in the content pages is rewritten. Each rewritten URL references a web page via the server 110, more specifically the adext.dll module of the server 110, rather than referencing the web page directly. In one embodiment, an advertisement ID is added to the content page.

Code in the frames page, e.g., JavaScript scripts, also sends a load advertisement request 413 to the advertisement program module 420. In response to this request, the advertisement frame causes an accessing 421 of the advertisement table 430 to get a list of advertisements associated with the content page being loaded into the content frame or most recently loaded into the content frame. In response to this request, the advertisement table 430 returns 431 the advertisement list to the advertisement program module 420. The advertisement program module 420 randomly selects an advertisement from the list. An advertisement page program module, e.g., the advertisement page program module 215 (shown in FIG. 2), is appended to the selected advertisement and returned 422 to the client. In another embodiment, the advertisement ID in the content page is used to select an advertisement to be returned to the client.

The frames page also sends to the daemon program module 425 a request to load a blank page 414 into the daemon frame. In response, the daemon program module 425 returns 426 a blank static web page to the client. The static web page is blank in that it does not contain displayable or viewable content. The static web page includes scripts that survive transitions between displays of content in the content frame and advertisements in the advertisement frame. When a user clicks on the “HOLD” or “HOME” buttons described above, the advertisement page program module, e.g., the advertisement page program module 215 (shown in FIG. 2), captures these click events and sends a request for script to be loaded into the daemon frame. Additionally, the advertisement page program module, e.g., the advertisement page program module 215 (shown in FIG. 2), also provides information regarding the click events to script in the daemon frame.

It is to be noted that the index program module 410, the content program module 415 and the advertisement program module 420 run on the server side, whereas the frames page program module 205, the content page program module 210, the advertisement page program module 215 run on the client side. It is also to be noted that, in one embodiment, the index program module 410 includes the frames processor 320 (shown in FIG. 3). Similarly, in one embodiment, the content program module 415 includes the content processor 325 (shown in FIG. 3). Similarly, in one embodiment, the advertisement program module 420 includes the advertisement processor 330 and advertisement hit processor 335 (shown in FIG. 3).

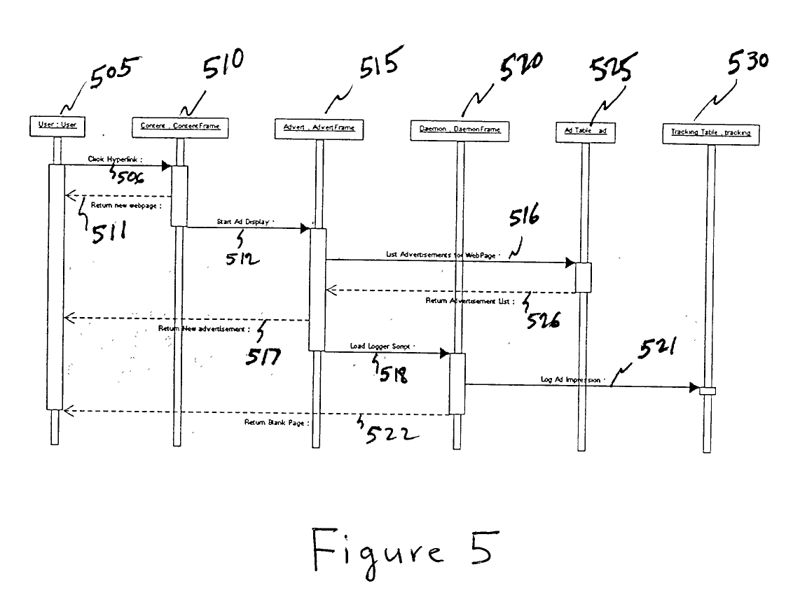

FIG. 5 is an interaction diagram for navigating a web site in conjunction with one embodiment of the method of the present invention. The interaction diagram of FIG. 5 deals with navigating a web site enabled with the software of the present invention. More specifically, it deals with navigating such a web site after browsing the web site, such as, for example, as described in conjunction with FIG. 4. When the user 505 clicks 506 on a hyperlink in the content frame, code, e.g., JavaScript scripts, in the content frame, notifies the advertisement frame to stop displaying the advertisement in the advertisement frame. Furthermore, the content program module returns 511 the web page associated with the hyperlink to the client. In one embodiment, the content page is processed and/or has scripts/information (such as scripts in the content page program module 210, the single line JavaScript script described above, or advertisement ID) appended thereto before it is returned to the client. This web page is loaded into the content frame, thus replacing the web page previously loaded in the content frame. Moreover, a start advertisement display request 512 is sent from the content program module 510 to the advertisement program module 515. In response to this request, the advertisement program module 515 accesses 516 the advertisement table 525 to get a list of advertisements associated with the content being loaded into the content frame or most recently loaded into the content frame. In response to the request for the list of advertisements, the advertisement table returns 526 the advertisement list to the advertisement program module 515. The advertisement program module 515 randomly selects an advertisement from the list, and sends 517 the selected advertisement to the client. In one embodiment, scripts (such as those included in the advertisement program module 215) are appended to the advertisement before it is returned to the client. The new advertisement is filled into the advertisement frame and is shown immediately in the advertisement frame on the client screen.

It is to be noted that the content program module 510 and the advertisement program module 515, like their counterparts in FIG. 4 (i.e., content program module 415 and advertisement program module 420, respectively) run on the server side. It is also to be noted that, in one embodiment, the content program module 510 includes the content processor 325 (shown in FIG. 3). Similarly, in one embodiment, the advertisement program module 515 includes the advertisement processor 330 and advertisement hit processor 335 (shown in FIG. 3).

The advertisement program module 515 also sends 518 a load logger script request to the daemon program module 520. Consequently, the daemon frame is loaded with the logger script. The daemon program module 520 sends 521 a request to the tracking table 530 to log the advertisement impression. As a result, the tracking table 530 records an impression event for the advertisement impression in the tracking table. Additionally, the daemon program module 520 returns 522 a blank page to the client.

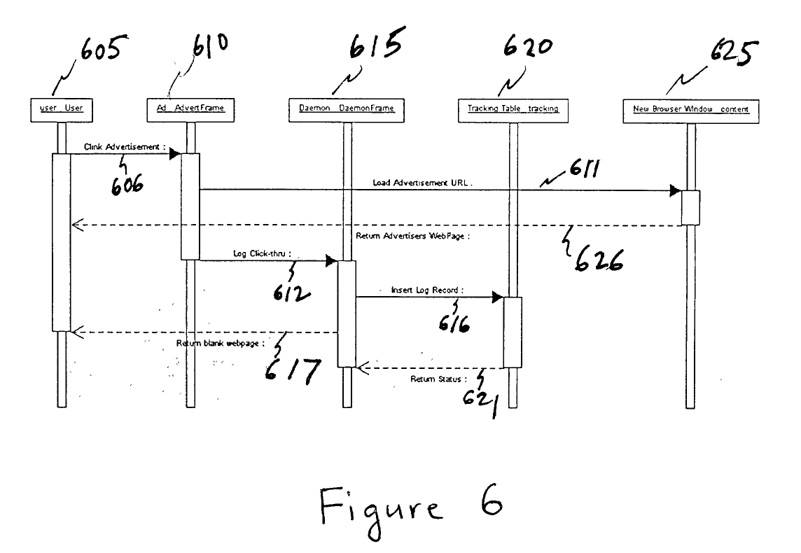

FIG. 6 is an interaction diagram for clicking on an advertisement in conjunction with one embodiment of the method of the present invention. The interaction diagram of FIG. 6 deals with clicking on an advertisement after browsing a web site enabled with the software of the present invention. More specifically, it deals with clicking on an advertisement after browsing the web site, such as, for example, as described in conjunction with FIG. 4. When a user 605 clicks 606 on the Learn More (HOME) button, or the advertisement, in the advertisement frame, code, e.g., JavaScript scripts, in the advertisement program module 610, opens a new browser window 625 and loads 611 the destination URL for the advertisement into the new browser window 625. In response, the new browser window 625 returns 626 the advertiser's web page to the client. Moreover, code, e.g., JavaScript scripts, in the advertisement program module 610, sends a log click-through request 612 to the daemon program module 615 to record the click-through in the tracking table 620. In one embodiment, this request is sent at the same time as the request to load the advertisement URL. In response to the log click-through request 612, the daemon program module 615 sends an insert log record request 616 to the tracking table 620. As a result, the click-through log record is inserted into the tracking table 620. The tracking table 620 sends a return status message 621 to the daemon program module 615. The return status message indicates whether the click-through log record is successfully inserted into the tracking table. Furthermore, the daemon program module 615 returns 617 a blank web page to the client.

It is to be noted that the advertisement program module 610, like its counterpart in FIG. 4 (i.e., advertisement program module 420) runs on the server side. It is also to be noted that, in one embodiment, the advertisement program module 610 includes the advertisement processor 330 and advertisement hit processor 335 (shown in FIG. 3).

As noted in the configuration table above, when ExternalAds is set to Yes, then external advertisements (served by other advertisement servers, rather than the server 110) will be displayed. As also noted in the configuration table above, when ExternalAds is set to any other value (for example, No), then external advertisements will not be displayed on the local web site.

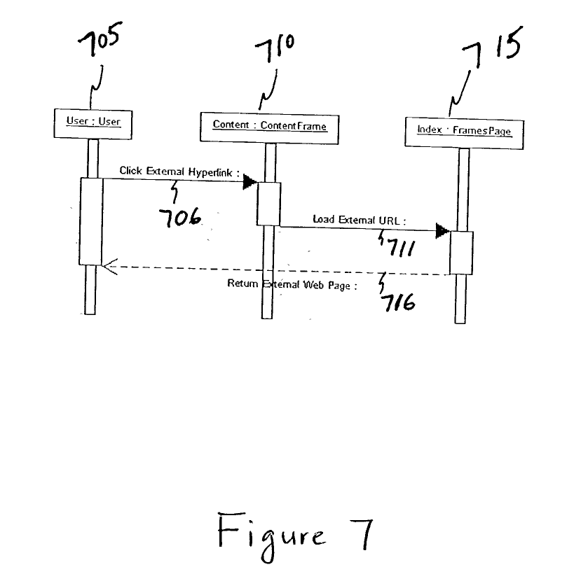

FIG. 7 is an interaction diagram for exiting a web site in conjunction with one embodiment of the method of the present invention. The interaction diagram of FIG. 7 deals with exiting a web site enabled with the software of the present invention. More specifically, it deals with exiting such a web site after browsing the web site, such as, for example, as described in conjunction with FIG. 4. If ExternalAds is disabled (i.e., not set to Yes), then when the user 705 clicks 706 a hyperlink that refers to an external web site that is not enabled with the software of the present invention, code, e.g., JavaScript scripts, in the content program module 710, causes the external URL to be loaded 711 in the top level frames page, completely replacing the current web site content and advertisement with content from the external web site. In other words, as shown in FIG. 7, clicking 706 the external hyperlink to a web site that is not enabled with the software of the present invention causes the content program module 710 to send a load external URL request 711 to the index program module 715. In response, the index program module 715 returns 716 the external web page to the client. If the ExternalAds is enabled (i.e., ExternalAds is set to Yes), then hyperlinks to an external web site are handled the same way as hyperlinks within the current web site which is enabled with the software of the present invention.

It is to be noted that the index program module 715 and the content program module 710, like their counterparts in FIG. 4 (i.e., index program module 410 and content program module 415, respectively), run on the server side. It is also to be noted that, in one embodiment, the index program module 715 includes the frames processor 320 (shown in FIG. 3). Similarly, in one embodiment, the content program module 710 includes the content processor 325 (shown in FIG. 3).

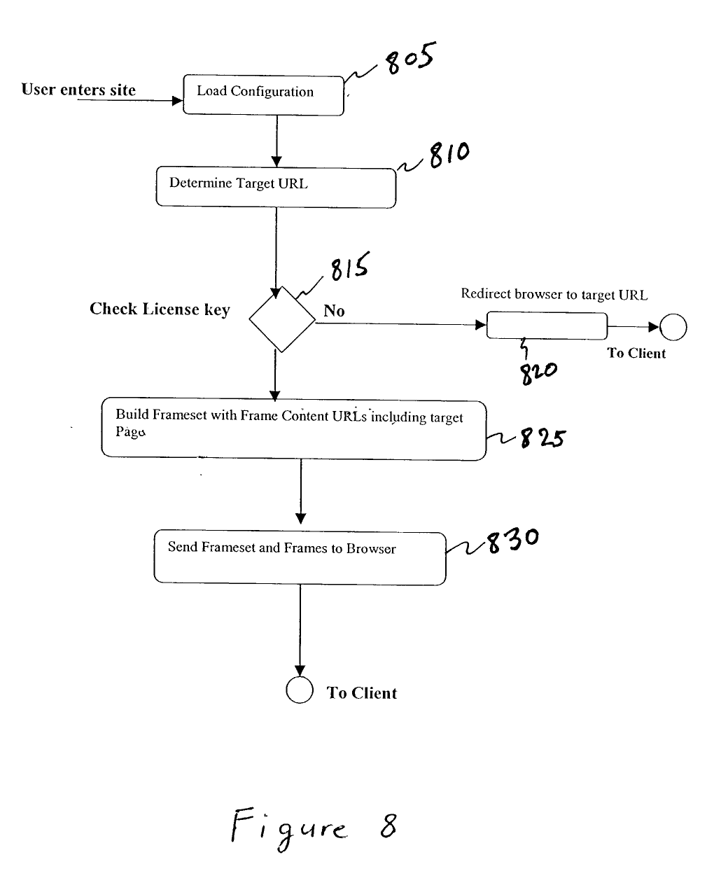

FIG. 8 shows a flowchart of major functions of the frames page builder script (index.php) in one embodiment of the present invention. Appendix 6 shows an example of JavaScript scripts included in the frames page builder script (index.php). As shown in FIG. 8, when a user enters a site (e.g., a web site), in step 805, the server loads configuration into its memory. Thereafter in step 810, the server determines the target URL of the default page for the web site. In step 815, the server checks the license key to determine if the web site corresponding to the target URL is a licensed customer for using the software of the present invention. If it is determined in step 815 that the web site corresponding to the target URL is not a licensed customer, then the process continues at step 820. In step 820, the browser is directed to the target URL. Thereafter, the web page associated with the target URL is returned to the client. On the other hand, if it is determined in step 815 that the web site corresponding to the target URL is a licensed customer, then the process continues at step 825. In step 825, the software at the server 110 builds a frameset with frame content URL's including the target page, i.e., the web page originally requested by the user. In step 830, the server 110 sends the frameset and frames to the browser, more specifically, to the browser at the client.

In one embodiment, the content frame displays the original web site content, as modified by the Content Caching script (adload.php). In one embodiment, the Content Caching script is included in the content program module 415. Seamless integration with existing web site content is achieved by rewriting many HTML tags and attributes, and appending JavaScript code to manage the routing of hyperlink click events to the advertisement frame. In one embodiment, the frame loading script edits the content page to rewrite the HTML tags and append the JavaScript code to manage the routing of hyperlink click events to the advertisement frame. HTML tags may, for example, be rewritten so as to refer to the proper URL of the desired object. The appended JavaScript code is used to notify the advertisement frame of click events in the content page. In another embodiment, the above functionality is performed by Microsoft Visual Basic Script code or JScript code instead of JavaScript code. More generally, the above functionality need not be performed by a script language as it can be performed by other software code.

In one embodiment, in order to enhance performance, the Content Caching Script (adload.php) stores a fully rewritten version of each content page accessed in the “cache” folder. Given that the original page has not been modified and the page is being requested without query parameters, the cached version of the page is returned to the web browser, avoiding the overhead of reprocessing each web page to rewrite HTML tags and attributes each time it is accessed.

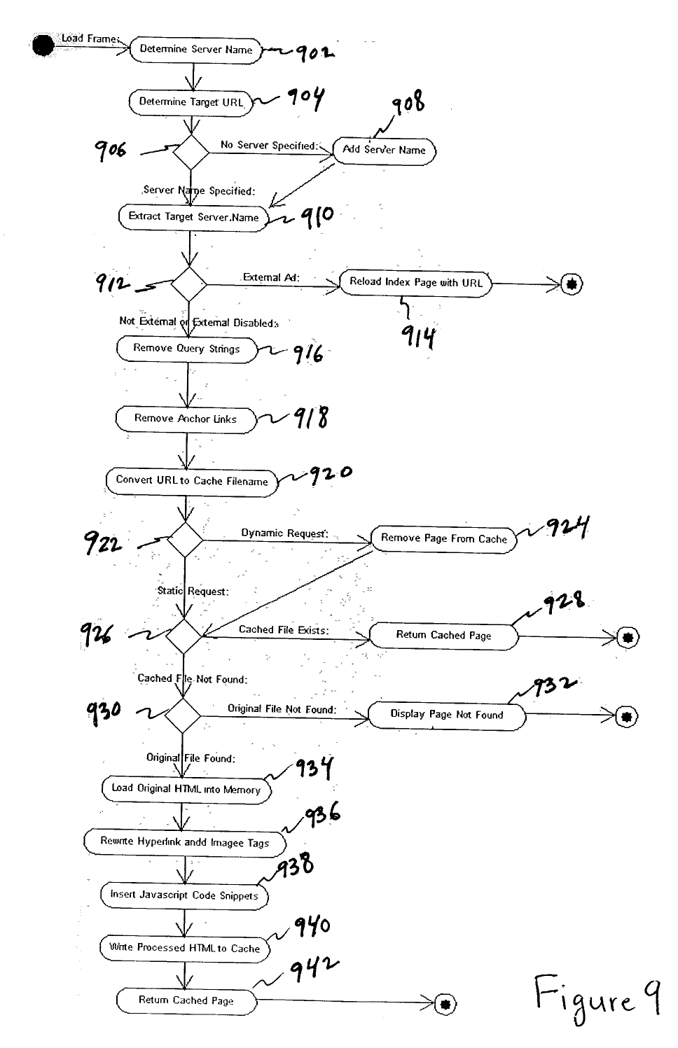

FIG. 9 shows a flowchart of major functions of the content caching script (adload.php) in one embodiment of the present invention. Appendix 7 shows an example of JavaScript scripts included in the content caching script (adload.php). When the request to load the content frame is issued by the load content code in the frames page, the process proceeds to step 902. In step 902, the content caching script determines the server name for the web server with pages for the content frame. In step 904, the content caching script determines the target URL. In step 906, the content caching script determines whether a target server name is specified. If it is determined, in step 906, that a target server name is not specified, then the process proceeds to step 908. In step 908, the content caching script adds a target server name. Thereafter, the process proceeds to step 910. If it is determined in step 906 that a target server name is specified, then the process proceeds to step 910 without going through step 908. In step 910, the content caching script extracts the target server name. In step 912, the content caching script determines whether external advertisements are enabled in conjunction with the target URL. In other words, it determines whether advertisements are to be displayed when showing pages from the target URL. If external advertisements are enabled, then the process proceeds to step 914. In step 914, the content caching script reloads the index page with the target URL. If external advertisements are disabled or if the target URL is not external, then the process proceeds to step 916. In step 916, the content caching script removes query strings. In step 918, the content caching script removes anchor links. In step 920, the content caching script converts the target URL to a cache filename. In step 922, the content caching script determines whether the target URL includes dynamic, rather than static, data. If, in step 922, it is determined that the target URL includes dynamic data, then the process proceeds to step 924. In step 924, the content caching script removes the requested page from cache. Thereafter, the process proceeds to step 926. If, in step 922, it is determined that the target URL does not include dynamic data, then the process proceeds to step 926 without going through step 924. In step 926, the content caching script determines if a cached file exists. If, in step 926, it is determined that a cached file exists, then the process proceeds to step 928. In step 928, the cached page is returned. If, in step 926, it is determined that a cached file is not found, then the process proceeds to step 930. In step 930, it is determined whether an original file is found. If, in step 930, it is determined that an original file is not found, then the process proceeds to step 932. In step 932, a message that the page is not found is displayed at the client. If, in step 930, it is determined that an original file is found, then the process proceeds to step 934. In step 934, the original HTML is loaded into memory. In step 936, the hyperlinks and image tags are rewritten. In step 938, JavaScript code snippets are inserted. These JavaScript code snippets include, for example, the scripts for handling mouse click events described above. In step 940, the processed HTML is written to cache. In step 942, the cached page is returned.

As noted above, in one embodiment, instead of rewriting the content page before sending it to the client, a one line JavaScript script is added to the content page. In such a case, the content page with the one line JavaScript script added thereto may be cached before it is sent to the client. Alternatively, it may be sent to the client without first being cached.

In one embodiment, the advertisement frame displays the advertisement for the most recently loaded web page using the Advertising Display Script (adview.php). Advertising content is retrieved from HTML files stored on the advertising server (internal or external), as rewritten by the Display Script to insure that HTML Tags and Attributes for image, flash, video, etc. content refer to the correct URL within the web site. Additionally, JavaScript code (which in one embodiment is included in the advertisement page program module 215) is appended to manage timers and handle advertising click events. In one embodiment, a timer is used to control the amount of time during which an advertisement is displayed. For example, as noted above, in one embodiment, an advertisement is displayed until a duration timer runs out.

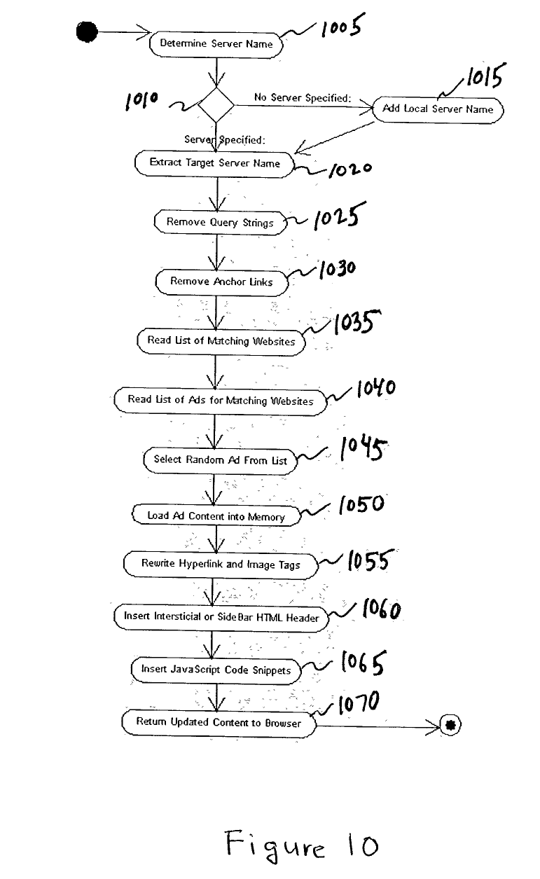

FIG. 10 shows a flowchart of major functions of the advertisement display script flow chart (adview.php) in one embodiment of the present invention. Appendix 8 shows an example of JavaScript scripts included in the advertisement display script (adview.php). In step 1005, the advertisement display script determines the server name. In step 1010, it is determined whether a server is specified. If, in step 1010, it is determined that no server is specified, then the process proceeds to step 1015. In step 1015, a local server name is added. Thereafter, the process proceeds to step 1020. If, in step 1010, it is determined that a server is specified, then the process proceeds to step 1020 without going through step 1015. In step 1020, the target server name is extracted. In step 1025, query strings are removed. In step 1030, anchor links are removed. In step 1035, a list of matching web sites are read. In step 1040, a list of advertisements for the matching web sites are read. In step 1045, an advertisement is randomly selected from the list of advertisements. In step 1050, the advertisement content is loaded into browser memory. In step 1055, the hyperlink and image tags are rewritten. In step 1060, an interstitial or side bar HTML header is inserted. In step 1065, JavaScript code snippets are inserted. In step 1070, the updated content is returned to the browser.

As noted above, in one embodiment, a advertisement ID is added to the content page before it is sent to the client 105. In such a case, the advertisement is selected, not randomly, but based on the advertisement ID.

It is to be noted that the present invention allows displaying advertisements in the split screen or interstitial mode without hard recoding of the web pages in conjunction with which the advertisements are delivered. In other words, the present invention can be practiced without manual script inserting or re-programming of web pages to enable different modes of advertisement display. The present invention is completely soft coded and can be modified or removed through administration screens.

While the present invention has been described in the context of content and advertisement delivery, it is not limited to use in this context. For example, the method of the present invention can be applied to an e-mail system, a file transfer, a bulletin board, a chat room, or a closed circuit television. Additionally, while the present invention has been described with respect to one advertisement, one skilled in the art would recognize that multiple advertisement frames could be included in the frames page. In such a case, it may be advantageous to include additional script program code to facilitate the management of multiple advertisement pages. Such additional code may, for example, coordinate display of multiple advertisements, either sequentially or simultaneously, in the time period between the display of content pages.

While the present invention has been particularly described with respect to the illustrated embodiments, it will be appreciated that various alterations, modifications and adaptations may be made based on the present disclosure, and are intended to be within the scope of the present invention. While the invention has been described in connection with what are presently considered to be the most practical and preferred embodiments, it is to be understood that the present invention is not limited to the disclosed embodiment but, on the contrary, is intended to cover various modifications and equivalent arrangements included within the scope of the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of delivering content and advertisement, the method comprising:
receiving a request for a target web page;
sending, in response to the request for the target web page, a frames page comprising a plurality of frames and a frames page program module, wherein the plurality of frames comprises a content frame and an advertisement frame;
receiving a request to load the content frame;
sending content to load the content frame, wherein the content comprises the target web page;
receiving a request to load the advertisement frame; and
sending an advertisement to load the advertisement frame.

2. The method of claim 1 further comprising:
determining whether the request for the target web page is a first request during a current session.

3. The method of claim 1, wherein the request to load the content frame and the request to load the advertisement frame are prompted by the frames page program module.

4. The method of claim 1 further comprising:
retrieving a list of advertisements from an advertisement table; and
selecting the advertisement from the list.

5. The method of claim 4, wherein said selecting the advertisement comprises randomly selecting the advertisement from the list.

6. The method of claim 1, wherein the plurality of frames further comprises a daemon frame.

7. The method of claim 6, wherein the daemon frame is initially loaded with a blank page.

8. The method of claim 6, wherein the daemon frame is loaded with server-side scripted content.

9. The method of claim 8 further comprising receiving a request to insert advertising event information into a tracking database.

10. The method of claim 1 further comprising:
modifying the content by adding a content page program module to the content, wherein the content page program module comprises software for performing the following function:
handling mouse click events.

11. The method of claim 10, wherein the content page program module further comprises software for performing the following functions:
handling window OnLoad events; and
handling window OnBeforeUnload events.

12. The method of claim 1 further comprising:
modifying the advertisement by adding an advertisement page program module to the advertisement, wherein the advertisement page program module comprises software for performing the following functions:
displaying HOLD and HOME buttons; and
handling button click events for the HOLD and HOME buttons.

13. The method of claim 1, wherein the frames page program module comprises software for performing the following functions:
loading content; and
loading advertisement.

14. The method of claim 13, wherein the frames page program module further comprises software for performing the following functions:
handling hyperlink mouse click actions; and
allocating screen area.

15. The method of claim 1, wherein the frames page program module comprises software for causing display of the advertisement frame concurrently with the content frame.

16. The method of claim 1, wherein the frames page program module comprises software for causing display of the advertisement frame between, in terms of time, display of two successive content pages.

17. The method of claim 16, wherein the frames page program module comprises software for causing the advertisement frame, loaded with the advertisement, to be stored in a browser cache while the content is displayed.

18. The method of claim 17, wherein the frames page program module comprises software for causing the advertisement frame, loaded with the advertisement, to be displayed when a user requests to view another content page.

19. The method of claim 16, wherein, in an interstitial mode, prior to a hyperlink click action by a user, the advertisement loaded in the advertisement frame is not viewable by the user, further wherein upon the hyperlink click action by the user, the frame is displayed instantly to the user.

20. A method of delivering content and advertisement, the method comprising:
receiving a request for a target web page;
sending, in response to the request for the target web page, a web page that causes, directly or indirectly, establishing a frames page comprising a plurality of frames and a frames page program module, wherein the plurality of frames comprises a content frame and an advertisement frame;
receiving a request to load the content frame, wherein the request to load the content frame is prompted by the frames page program module;
sending content to load the content frame, wherein the content comprises the target web page;
receiving a request to load the advertisement frame, wherein the request to load the advertisement frame is prompted by the frames page program module; and
sending an advertisement to load the advertisement frame.

21. The method of claim 20, wherein the web page includes code that invokes a program, wherein execution of the program by a browser causes establishing the frames page.

22. The method of claim 20, wherein the web page comprises a program, wherein execution of the program by a browser causes establishing the frames page and the plurality of empty frames.

23. The method of claim 20, wherein the plurality of frames further comprises a daemon frame.

24. The method of claim 20, wherein the frames page program module comprises software for causing display of the advertisement frame along with the content frame.

25. The method of claim 20, wherein the frames page program module comprises software for causing display of the advertisement frame between display of successive content pages.

26. The method of claim 25, wherein the frames page program module comprises software for causing the advertisement frame, loaded with the advertisement, to be stored in a browser cache while the content is displayed.

27. The method of claim 26, wherein the frames page program module comprises software for causing the advertisement frame, loaded with the advertisement, to be displayed when a user requests to view another content page.

28. A method of delivering content and advertisement, the method comprising:
receiving a request for a target web page; and
sending, in response to the request, a modified target web page, wherein a hyperlink in the modified target web page has a corresponding hyperlink in the target web page, wherein the corresponding hyperlink references a first server, further wherein a request using the hyperlink in the modified target web page is directed to a server other than the first server, further wherein the modified target web page includes code that, upon a hyperlink click on the modified target web page, invokes functionality of a frames page program module to resize a content frame and an advertisement frame.

29. The method of claim 28, wherein the target web page is modified by rewriting the corresponding hyperlink to a rewritten hyperlink, wherein the rewritten hyperlink references software modules at the server.

30. The method of claim 28, wherein the target web page is modified by adding thereto code that intercepts the hyperlink click on the modified target web page, further wherein the code directs requests based on the hyperlink click to the server.

31. The method of claim 30, wherein the code invokes a program, wherein execution of the program by the browser causes establishing a frames page comprising a plurality of frames and the frames page program module, wherein the plurality of frames comprises the content frame and the advertisement frame.

32. The method of claim 30, wherein the plurality of frames further comprises a daemon frame.
